(19) United States
(12) Patent Application Publication
(10) Pub. No.: US 2004/0114823 A1
(43) Pub. Date: Jun. 17, 2004

(54) Image focusing methods and apparatus

(76) Inventors: Brian John Edward Smith, Yate, Bristol (GB); Francis William John Gibbs, Bristol (GB); Ian Mac Bell, Gloucestershire (GB)

Correspondence Address: Oliff & Berridge, PO Box 19928, Alexandria, VA, 22320, US

(21) Appl. No.: 10/472,047

(22) PCT Filed: Apr. 8, 2002
(86) PCT No.: PCT/GB02/01514

(30) Foreign Application Priority Data
Apr. 6, 2001 (GB) 0108697.4

(51) Int. Cl. G06K 9/40

(52) U.S. Cl. 382/255

(57) ABSTRACT

The invention relates to a method and apparatus for focusing structured image such as a laser spot. A method for determining the degree of focus of such a structured image are disclosed whereby: an image is provided at a photosensitive array formed from a plurality of elements; the position of the image is determined; for an element of the array a weighting is assigned according to the position of that element relative to the position of the image; the intensity of the image at the element is determined; a value is produced for the element dependent on its weighting and the intensity of the image thereat. In addition the values of the plurality of elements are summed and one overall focus value is found which is indicative of the degree of focus of the image. This value is used to search for and maintain best focus and methods for achieving this are disclosed also. Apparatus is shown in which a microprocessor and a controller are used to perform the methods disclosed.

This invention relates to a method and apparatus for determining the correct focus for an image, and/or for searching for the best focus, and/or for maintaining that focus once found, particularly, but not exclusively, a laser light image.

Microscope and camera images are conventionally automatically focused by adjusting the position of the objective lens in response to the analysis of an image. The focus of the image is analysed by determining its intensity profile or high frequency content. Smooth changes in intensity indicate an out-of-focus image (see FIG. 2A), whereas sudden changes in intensity indicate an in-focus image (see FIG. 2B). A lack of high frequency content in image indicates also an out-of-focus image.

Conventionally methods of image analysis are not satisfactory when trying to determine the degree of focus of a laser light image because such images are prone to speckle i.e. diffraction noise which in turn gives sudden changes in intensity and a large high frequency light content (even when the image is out-of-focus). Therefore an out-of-focus laser light image looks like an in-focus image when the above-mentioned conventional image analysis techniques are used.

A new approach has been developed for determining the degree of focus of a structured image which is characterised by the following steps: providing an image at a photosensitive array formed from a plurality of elements; determining the position of the image (for example by observation of the position at which the image falls or by analysis of the image); assigning for an element of the array a weighting according to the position of that element relative to the position of the image; determining the intensity of the image at the element; and producing a value for the element dependent on its weighting and the intensity of the image thereat.

Preferably a further step is used i.e. summing the values of the plurality of elements to produce one so-called “merit function”, which is indicative of the degree of focus of the image. In the claims the “merit function” is called the “overall focus value” to define it more clearly.

Another problem associated with focusing is finding the best focus and the maintaining that focus, e.g. during use of a device that might change shape say due to thermal expansion.

Conventionally one way in which focus searching is carried out is to adjust slightly the objective lens in a first direction and to measure the image intensity profile or its high frequency content as discussed above. A smoother profile than the original or less high frequency light will result in another adjustment of the objective in the opposite direction to the first, whereas a more contrasting profile or more high frequency light will result in another adjustment in the same direction as the first. In this way iterative adjustments are made toward the optimal focus.

A new approach to searching for best focus or maintaining focus has been developed and is characterised by the following steps:

determining the merit function (as defined above) of an image; and

adjusting the focus of the image and re-determining the merit function.

So if the merit function decreases from one measurement to the next then the adjustment direction can be reversed. If the merit function increases then a further adjustment can be made in the same direction.

Preferably, the adjusting takes place in a plurality of increments (e.g. 100 micron adjustments) and the re-determining of the overall focus value is carried out at each of those plurality of increments, and wherein an additional step i) is provided whereat a starting position for a further plurality of increments is determined at the increment having the best overall focus value, and the step h) of this claim is repeated until the starting position is approximately in the middle of the further plurality of increments.

Preferably the first plurality of increments is in both directions (i.e. plus and minus) in relation to the focus when the initial overall focus value is determined and the further plurality of increments is in both directions in relation to the starting position.

Alternatively when the starting position is at one end of the first plurality of increments then the further plurality of increments are in the direction of that end.

For focus maintenance, the adjusting may take place in a plurality of increments and the re-determining of the overall focus value is carried out at each of those plurality of increments, and wherein an additional step j) is provided whereat a starting position for a further plurality of increments is determined at a position between the two of the said increments which have the best overall focus value, and the step h) of this claim is repeated using further pluralities of increments to either side of the starting position.

The invention encompasses apparatus for the above methods.

The invention will now be described with reference to the drawings in which:

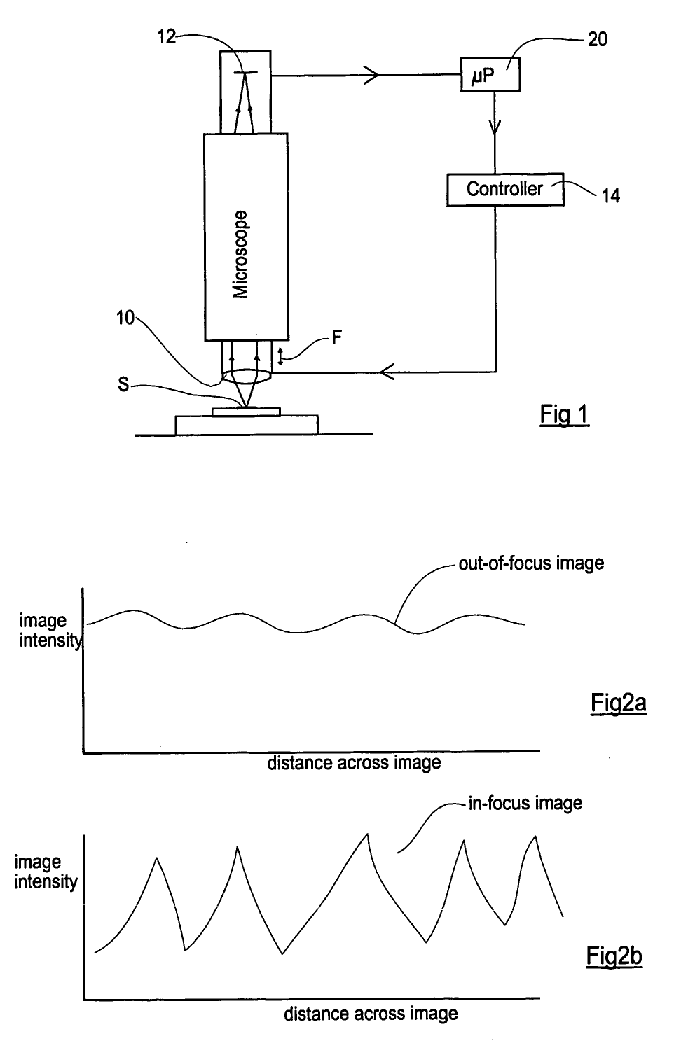

FIG. 1 shows typical apparatus for the method of the invention;

FIG. 2 shows typical image intensity profiles measured by known techniques;

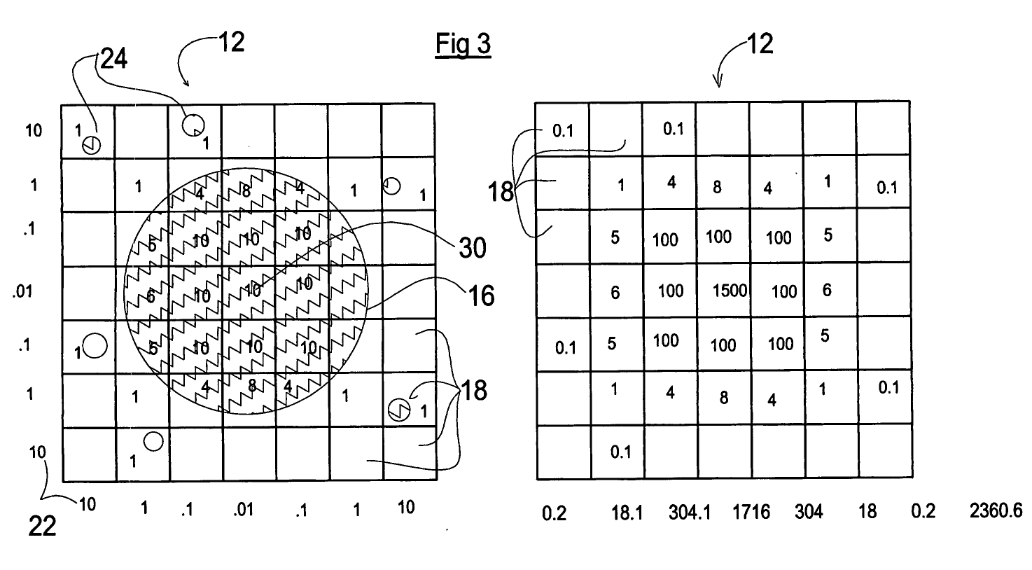

FIG. 3 shows a photosensitive array and a merit function table both illustrating the method of the invention when in use with an out-of-focus spot;

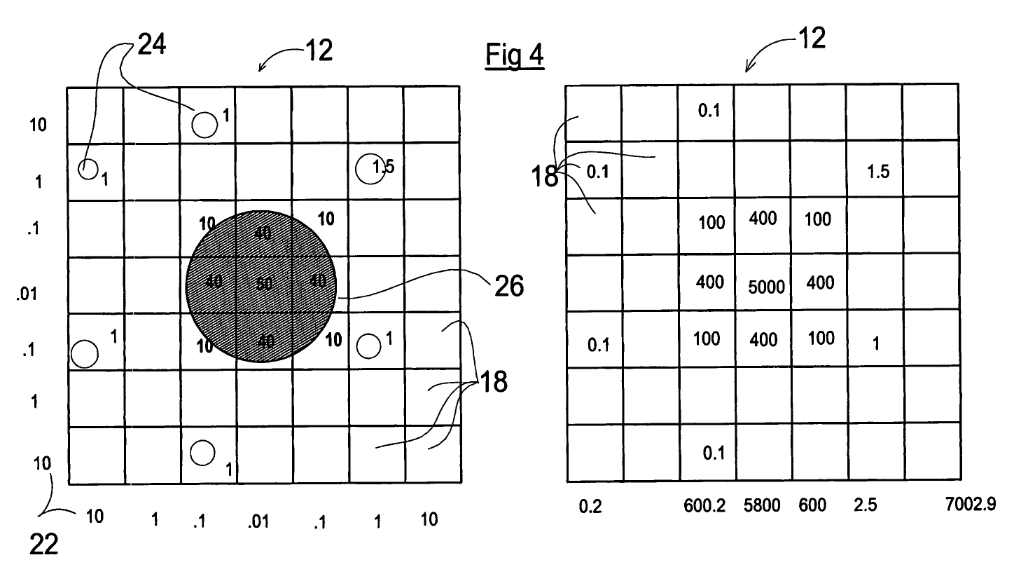

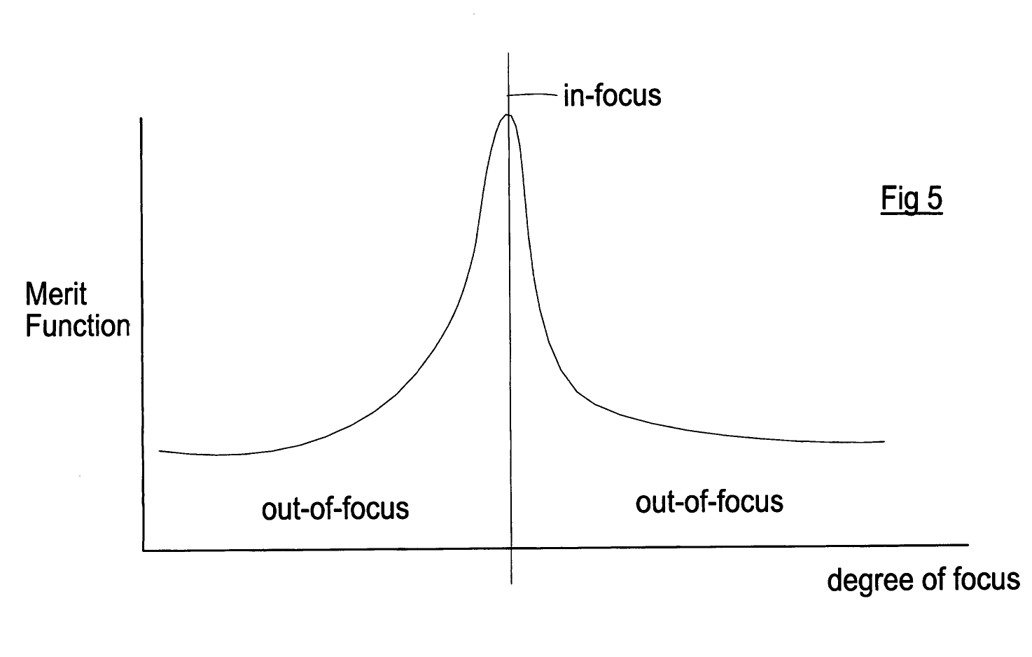

FIG. 4 shows the same photosensitive array and function table shown in FIG. 3, however a focused spot is illustrated in this Figure;

FIG. 5 shows a typical plot of the merit function as an image moves into and back out of focus; and

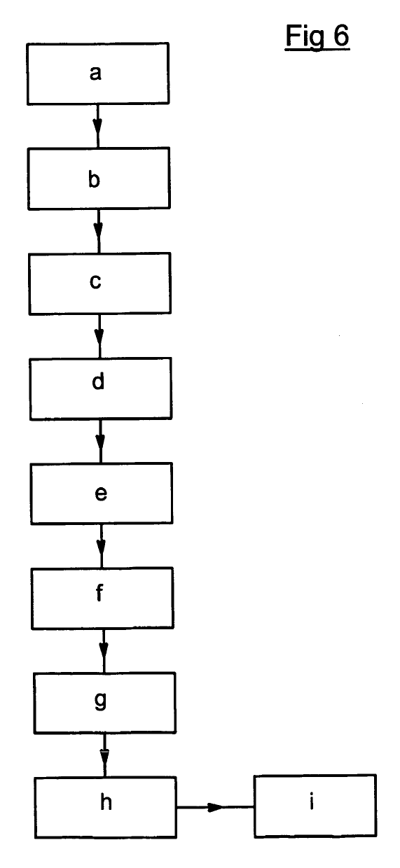

FIG. 6 shows a flow chart of a method of focusing as described herein.

Referring to FIG. 1 there is shown a microscope with an automatic focusing device which moves the objective lens 10 in the directions of arrow F. An image of the sample S is focused onto a charge-coupled device (CCD) 12. The known focusing mechanism is under the control of a controller 14 which operates in the manner described below. The image from the CCD 12 is analysed and processed by processor 20, and a signal is sent to the controller 14 to adjust the focus of the microscope either initially or to maintain focus during use of the microscope.

It will be appreciated that use of a microscope is illustrative only of one application of the invention. Focusing in any apparatus can be carried out using the method of the invention.

FIGS. 2A and 2B illustrate a prior art method of determining image focus. A line through an image is analysed and its image intensity is measured. As previously discussed, smooth transitions in image intensity along the line (FIG. 2A) are indicative of an out-of-focus image, whereas a discontinuous image intensity is indicative of an in-focus image (FIG. 2B).

An out-of-focus laser spot image 16 is shown in FIG. 3. As mentioned previously diffraction speckle 24 is present, even when the spot is unfocused. A portion of the CCD 12 is shown in the Figure. The portion has a number of rows and columns of pixels 18 (here shown greatly enlarged for clarity). The position of the image may be known in advance, for example by observation, or may be determined by analysis of the image i.e. using the output of the CCD to find a relatively large area of high intensity light. Once the position of the spot has been determined its degree of focus can be determined also.

The degree of focus can be determined by firstly assigning to each pixel or group of pixels a weighting. The weighting will be dependent on the distance of that pixel (or group) to a mid-position of the spot image. So, in FIG. 3 the values 22 represent the weighting. Thus the central pixel 30 of the CCD array 12 will have a weighting of 0.01, the 8 pixels surrounding that central pixel will have a weighting of 0.1, the 16 pixels surrounding the 9 central pixels will have a weighting of 1 and the pixels surrounding those will have a weighting of 10. The values given in the array to the left are the light intensity for each pixel (no number=zero intensity). The summation table at the right of FIG. 3 represents the same CCD array 12 with the same image but the values in the table represent the image intensity divided by the weighting value for each pixel.

The values under the array to the right are the sum for each column of the array and the grand total is shown at the right. This grand total is referred to in this description as the “merit function”, and in the claims as an “overall focus value”.

The same CCD array 12 is shown in FIG. 4, however an in-focus image 26 is now illustrated. The weighting values are the same but the intensity of the focused image is greatly enhanced at the focal area and so the values of image intensity divided by weighting at the focal area are increased, whereas the diffraction speckle areas have little effect on the overall value of the merit function because their weighting is reduced (they have a higher divisor). It can be seen that the focused image gives a larger merit function than the unfocused image.

FIG. 5 shows a typical plot of a merit function against the degree of focus of an image. This plot can be used to provide automatic focus maintenance.

The merit function can be used as a single “quality of focus” input value for methods of focus maintenance or searching.

Such a method involves adjusting the focus and going past the peak of optimum focus then reversing the adjusting direction of the focus to return to the optimum focus.

It has been found that the merit function can be used to provide a measure of focus for this technique.

Another technique is a bisecting method, whereby three or so degrees of image quality are determined and the poorest is disregarded. The focus is adjusted in the direction of the best value or to a position between the best two values until the optimum focus is reached.

The merit function can be used to provide an indication of image quality for this method also.

Another, method involves adjusting the focus in a random direction, measuring the merit function, if the merit function improves then moving again in the same direction, if the merit function is worse then moving in the opposite direction. This is a simple yet robust algorithm which will gradually follow the upward slope of the merit function shown in FIG. 5.

There will be many variants and modifications to the methods described herein which will be apparent to the addressee. The claims further define the steps of the focus searching and maintenance methods described above.

Whilst a spot of laser light has been used to illustrate the invention, the light need not be coherent laser light, it may be non-coherent light e.g. a focused spot of white light. The image may be of any shape, e.g. a line of light (in which case the distance from the centre of the line will form the basis for weighting of the various pixels), provided that the image is structured or of predetermined shape.

Whilst a small number of pixels 18 have been illustrated in FIGS. 3 and 4, in practice it is likely that a large array of pixels will be used, and therefore a larger number of weightings may be used also.

The invention extends to an apparatus for carrying out the methods described above and as claimed. The apparatus is shown in FIG. 1 and a flow chart corresponding to the steps of the methods claimed is shown in FIG. 6. The flow chart steps are carried out by the microprocessor and controller shown in FIG. 1.

1. A method for determining the degree of focus of a structured image comprising, in any suitable order, the following steps:
a) providing an image at a photosensitive array formed from a plurality of elements;
b) determining the position of the image;
c) assigning for an element of the array a weighting according to the position of that element relative to the position of the image;
d) determining the intensity of the image at the element;
e) producing a value for the element dependent on its weighting and the intensity of the image thereat.

2. A method according to claim 1 comprising a further step:
f) summing the values of the plurality of elements to produce one overall focus value which is indicative of the degree of focus of the image.

3. A method for searching for best focus or maintaining focus comprising, in any suitable order, the following steps:
g) determining an initial overall focus value of an image by carrying out the method according to claim 2;
h) adjusting the focus of the image and re-determining the overall focus value:

4. A method for focus searching according to claim 3 wherein at step h) the adjusting takes place in a plurality of increments and the re-determining of the overall focus value is carried out at each of those plurality of increments, and wherein an additional step i) is provided whereat a starting position for a further plurality of increments is determined at the increment having the best overall focus value, and the step h) of this claim is repeated until the starting position is approximately in the middle of the further plurality of increments.

5. A method for focus searching according to claim 4 wherein, at step h) the first plurality of increments is in both directions (i.e. plus and minus) in relation to the focus when the initial overall focus value is determined and the further plurality of increments is in both directions in relation to the starting position.

6. A method for focus searching according to claim 4 wherein, at step h), when the starting position is at one end of the first plurality of increments then the further plurality of increments are in the direction of that end.

7. A method for focus maintenance according to claim 3 wherein at step h) the adjusting takes place in a plurality of increments and the re-determining of the overall focus value is carried out at each of those plurality of increments, and wherein an additional step j) is provided whereat a starting position for a further plurality of increments is determined at a position between the two of the said increments which have the best overall focus value, and the step h) of this claim is repeated using further pluralities of increments to either side of the starting position.

8. Apparatus for determining the degree of focus of a structured image comprising:
means for providing an image;
a photosensitive array formed from a plurality of elements;
image position determining means;
means for assigning for an element of the array a weighting according to the position of that element relative to the position of the image;
means for determining the intensity of the image at the element; and
means for producing a value for the element dependent on its weighting and the intensity of the image thereat.

9. Apparatus according to claim 8 further comprising means for summing the values of the plurality of elements to produce one overall focus value which is indicative of the degree of focus of the image.
